(19) United States
(12) Patent Application Publication
(10) Pub. No.: US 2010/0179284 A1
(43) Pub. Date: Jul. 15, 2010

(54) POLYMERS WITH BIO-FUNCTIONAL SELF ASSEMBLING MONOLAYER ENDGROUPS FOR THERAPEUTIC APPLICATIONS AND BLOOD FILTRATION

(75) Inventors: Robert S. Ward, Berkeley, CA (US); Keith McCrea, Concord, CA (US); Yuan Tian, Alameda, CA (US); Shanger Wang, Fairfield, CA (US); Larry Jones, Oakland, CA (US); Anfeng Wang, Fremont, CA (US); James P. Parakka, San Bruno, CA (US)

Correspondence Address: BIRCH STEWART KOLASCH & BIRCH, PO BOX 747, FALLS CHURCH, VA, 22040-0747, US

(73) Assignee: DSM IP ASSETS B.V., HEERLEN (NL)

(21) Appl. No.: 12/601,787

(22) PCT Filed: May 28, 2008
(86) PCT No.: PCT/US08/64955

§ 371 Date: Dec. 14, 2009

Related U.S. Application Data
(60) Provisional application No. 60/940,796, filed on May 30, 2007.

(51) Int. Cl. C08B 37/10

(52) U.S. Cl. 525/54.2

(57) ABSTRACT

Medical device, prosthesis, or packaging assembly made up of polymer body comprising at least one polymer having the formula R(LE)x wherein R is a polymeric core having a number average molecular weight of from 5000 to 7,000,000 daltons, and having x endgroups, x is an integer≧1, E is an endgroup which is covalently linked to polymeric core R by linkage L, L is a divalent oligomeric chain which has at least 5 repeat units and which can self-assembly with L chains on adjacent molecules of the polymer, and moieties L and/or E in the polymer(s) may be the same as or different from one another in composition and/or molecular weight. The polymer body includes plural polymer molecules located internally within the body, at least some of which internal polymer molecules have endgroups that form a surface of the body. The surface endgroups include at least one self-assembling moiety.

### FIELD OF THE INVENTION

The present invention relates to medical devices, prostheses, packaging assemblies, and methods of blood filtration, all of which are improved due to their employment of polymers that contain bio-functional self-assembling monolayer endgroups (SAMEs). Examples of materials contemplated by the present invention include polyurethane tubing that is heparinized for use in blood filtration applications and polycarbonate urethane packaging material having germicidal quaternary ammonium salt endgroups.

### BACKGROUND OF THE INVENTION

WO 20071142683 A2 provides polymers having the formula

R(LE)ₓ

wherein R is a polymeric core having a number average molecular weight of from 5000 to 7,000,000 daltons, more usually up to 5,000,000 daltons, and having x endgroups, x being an integer≧1, E is an endgroup covalently linked to polymeric core R by linkage L, L is a divalent oligomeric chain, having at least 5 identical repeat units, capable of self-assembly with L chains on adjacent molecules of the polymer, and, when x>1, the moieties (LE)ₓ in the polymer may be the same as or different from one another, although in many cases, all of the moieties (LE)ₓ in the polymer are the same as one another. The present invention makes use of such polymers to provide novel therapeutic applications and improved blood filtration procedures.

Many stimulators, either exogenic or endogenic, can induce an inflammatory response that may present detrimental health problems. Autoimmune disorders are a source of endogenic stimulation while injury or disease transmission are exogenic sources. Viral or bacterial infection from tainted blood supplies is also a major concern leading to an inflammatory response. Proteins called cytokines are released by macrophages, monocytes, or lymphocytes in response to the invasion of bacterial or viral infection. The cytokines can then, if regulated, safely fight the foreign virus or bacteria by signaling T-cells or macrophages to the invasion site. However, if the cytokine response is unregulated, severe tissue damage can occur. Likewise, if cytokines are released in response to an autoimmune disorder, an unregulated high concentration of cytokines in the blood can complicate the body's ability to ward off such disorders.

During the inflammatory response, cytokines can stimulate their own production and thus lead to the “cytokine cascade.” This cytokine cascade can then, in some circumstances, increase the cytokine concentration to abnormal levels creating an amplification of the immune response leading to severe tissue damage.

Heparin is a highly sulfated glycosaminoglycan that exhibits an extremely high negative charge density. Heparin is well known to bind many proteins, including cytokines. Apheresis, through an extracoporeal device with heparinized surfaces allow the removal of pathogenic microorganisms, proteins, cytokines and cells from a patient's blood. The device may consist of medical tubing and one or more columns or cartridges filled with fibers, beads, foams or gels or other packing in which all or some of the blood contacting surfaces contain bound heparin. A pump and optional reservoir may be added to the circuit to return the purified blood or body fluid to the patient or direct it to a collection device. Fujita et al., Artificial organs, “Adsorption of inflammatory cytokines using a heparin-coated extracorporeal circuit” 2002, vol. 26(12) pages 1020-1025, discuss the use of heparinized surfaces for cytokine removal. However, Fujita et al. do not provide useful methods of manufacturing materials and devices for affinity therapy, nor is the heparinization technique discussed. The method employed by Fujita et al. for the study consisted of a commercially available extracoporeal device not intended for affinity therapy applications.

Crohn's disease is a chronic inflammatory disease of the intestines, and is closely related to another chronic inflammatory condition that involves only the colon, ulcerative colitis. Together these two disease groups are referred to as inflammatory bowel disease, or IBD. Ulcerative colitis and Crohn's disease have no medical cure. It is estimated that 1.4 million patients in the U.S. and another 2.2 million in Europe suffering from IBD. In North America, estimates of newly diagnosed cases of IBD range up to 100,000 each year, with Europe estimated at close to 110,000.

Sepsis is a condition that results from the immune system's response to severe infection leading to cardiovascular collapse and organ failure. It is one of the top ten causes of death in the U.S., killing over 200,000 Americans each year, more than from lung and breast cancer combined. Severe sepsis has reported mortality rates ranging from 29 to 60%. Over three quarters of a million new cases are identified in the U.S. annually, with an equally large case population in Europe and Asia. The disease typically attacks the elderly and its incidence is expected to increase in tandem with the aging population and as pathogens continue to become resistant to antibiotics. A research study done at Emory University and the Centers for Disease Control concluded that the incidence of sepsis increased an average of 8.7 percent a year over the past twenty-two years. Patients with severe sepsis require intensive care and account for a large proportion of ICU resource.

Diseases transmitted through the blood supply are a continuing problem both in the developed world and in developing nations. The American Red Cross requires testing be performed on each unit of donated blood for HIV/AIDS, hepatitis B and C, syphilis and human T-cell lymphotropic virus (HTLV). From time to time other tests are recommended by the U.S. Food and Drug Administration, as it did in 2003 by issuing a guidance for testing for Severe Acute Respiratory Syndrome (SARS) to blood establishments. This testing is expensive. Over 13.5 million units of blood are transfused in the U.S. every year, and while the risks of disease transmission are lowered due to this testing, there are still risks of other diseases being transmitted, such as cytomegalovirous (CMV), Epstein-Barr-virus (EBV), human herpes virus 6 (HHV-6), as well as Creutzfeldt-Jakob disease (CJD) and Lyme's disease. Risks are still greater in less developed countries where testing is less extensive and less affordable.

### SUMMARY OF THE INVENTION

During many procedures in which blood is processed, such as blood access, removal, oxygenation, dialysis, fractionation, and analysis, it is possible that infection or an inflammatory response can occur leading to severe complications such as sepsis. By using blood processing components that are made from polymers with self assembling monolayer end group (SAME) technology, infection or inflammatory complications can be avoided. Antimicrobial SAME groups prevent bacteria or microorganisms from propagating or spreading during dialysis or other blood access therapy. Heparinized SAME groups impart both antimicrobial and antithrombogenic properties to the materials surfaces for improved device efficacy. Additionally, heparinized SAME groups selectively bind cytokines, viral, microorganisms, and other inflammatory molecules for treating sepsis and autoimmune disorders such as Chron's disease. Cytokine storms also cause complications with burn victims and prevent immediate healing by the body. Removal of cytokines from blood of burn victims using heparinized affinity therapy devices could accelerate healing and greatly reduced associated morbidity with severe burns.

Bioactive surfaces can be prepared using SAME technology (disclosed in WO 2007/142683 A2). Polymers with surface active SAME groups are synthesized with either bioactive head groups or reactive functional head groups for post fabrication immobilization/attachment of bioactive groups. After a polymer with SAME technology is synthesized, a device is fabricated, the surface is allowed to ‘relax’, possibly using an accelerating environmental treatment, during which the SAME groups self assemble at the surface. If the head group of the SAME is biologically active, the surface will be biofunctional directly after relaxation, i.e. annealing. If the desired bioactive head group won't survive the harsh conditions required for polymer synthesis or processing, a reactive head group SAME can be used that will self assemble in the surface and present itself for post-fabrication reactive coupling of the biofunctional or biologically active moiety.

Optionally, a coupling agent bearing dual functional groups, X—R—Y, wherein X and Y are reactive functional groups and R is a linker, can be used to facilitate the attachment of biofunctional or biologically active moiety. The surface with self assembled SAME groups first react with one of the dual functional groups of a coupling agent, X or Y, and subsequently allowing for the attachment of biofunctional or biologically active moiety via a coupling reaction with a second functional group of the coupling agent. The design of configured articles made from the surface-modified polymer are virtually unlimited and include cartridges, columns or adsorption beds containing open cell foams, column packing, hollow fibers, membranes, or beads.

### BRIEF DESCRIPTION OF THE DRAWINGS

FIG. 1 depicts a general synthetic scheme for producing a heparinized surface on a polyether copolymer.

FIG. 2 depicts a general synthetic scheme for producing a phosphoryl choline-functionalized polyethylene copolymer.

FIG. 3 is a schematic depiction of the preparation of heparinized polyurethane tubing.

FIG. 4 is a schematic depiction of the use of heparinized tubing and heparinized filter media for blood purification in accordance with the present invention.

FIGS. 5 and 6 are schematic depictions of the use of a heparinized blood bag, heparinized tubing, and heparinized filter media for blood collection and transfusion in accordance with the present invention.

### DETAILED DESCRIPTION OF THE INVENTION

Polymeric biomaterials with immobilized biologically-active moieties attached to self-assembling monolayer endgroups (SAME) are prepared by synthesizing bulk polymers with surface-active end groups that include specific spacer and head group chemistries. These polymers are then used to fabricate medical devices and components. The end groups self assemble at the surface of the fabricated device/component and present one or more functional or biologically-active head groups. When an optionally-protected reactive/functional head group on the SAME is employed it is used for subsequent coupling to a biologically active moiety. For example, heparin, a preferred biologically-active moiety, imparts antithrombogenic properties to the surface of the device and also enhances the surface's affinity for viral, microbial, cytokines, or other pro-inflammatory or anti-inflammatory biologic molecules or cells contained in a bodily fluid or fractionated bodily fluid. The enhanced affinity for said unfavorable cells or molecules makes such polymers and devices made from them useful for affinity therapy and related applications that involve the contact of blood, serum, plasma or other bodily fluids with a surface for therapeutic, prophylactic or diagnostic applications. Such devices often include one or more high-surface-area components with the above-mentioned surface modification, e.g., cartridges, columns or adsorption beds containing open cell foams, column packing, hollow fibers, membranes, or beads. Other system components that may also be fabricated from polymers of this invention include pumps and circulatory assist devices, medical tubing, filters, fittings, cannulae and other components required for the access, removal, oxygenation, dialysis, fractionation, analysis, and/or circulation of body fluids, and their optional return to a human or animal patient. Only components of blood or body fluids are removed without addition of bioactive molecules to the blood or body fluids.

### Embodiments of the invention

1. An in vitro, ex vivo, or in vivo medical device or prosthesis or packaging assembly comprising a polymer body comprising at least one polymer having the formula

R(LE)ₓ

wherein R is a polymeric core having a number average molecular weight of from 5000 to 7,000,000 daltons, more usually up to 5,000,000 daltons, and having x endgroups, x being an integer≧1, E is an endgroup covalently linked to polymeric core R by linkage L, L is a divalent oligomeric chain, having at least 5 repeat units, capable of self-assembly with L chains on adjacent molecules of the polymer, and the moieties L and/or E in the polymer(s) may be the same as or different from one another in composition and/or molecular weight, although in many cases, all of the moieties (LE)ₓ in the polymer(s) are the same as one another, wherein the polymer body comprises a plurality of polymer molecules located internally within said body, at least some of which internal polymer molecules have endgroups that comprise a surface of the body, wherein the surface endgroups include at least one self-assembling moiety.
2.1. The medical device of embodiment 1, which is made from a heparinized filtration or affinity therapy/purification medium, e.g. beads, particles, hollow or solid fiber, open-cell or reticulated foam, porous or dense membranes, column packing, architectured films, or other shape with extended surface area, referred here in as “Affinity therapy/purification media”, and which is made of a polymer of the formula Heparin-CH₂—NH-SPACER-POLYMER-SPACER-NH—CH₂-Heparin, wherein POLYMER is a polymeric core with a MW of ≧5000 daltons and obtained by free radical addition polymerization, or by ionic polymerization or preferably by step growth condensation polymerization, wherein SPACER is a chemical moiety that is capable of self assembly by means of van der Waals interactions (for e.g. methylene groups and the like), or by electrostatic interactions, or by hydrogen bonding, or by ionic forces.
2.11. The “Affinity therapy/purification media” of embodiment 2.1, which is made of a polymer of the formula, Heparin-CH₂—NH—(CH₂)ₙ-polycarbonate-urethane-(CH₂)ₙ—NH—CH₂-Heparin, wherein the polycarbonate-urethane has MW≧5000 daltons, and wherein n is an integer greater than 4, preferably between 7 to 22.
2.12. The “Affinity therapy/purification media” of embodiment 2.1, which is made of a polymer of the formula, Heparin-CH₂—NH—(CH₂)ₙ-polyether-urethane-(CH₂)ₙ—NH—CH₂-Heparin, wherein the polyether-urethane has MW of ≧5000 daltons, and wherein n is an integer greater than 4, preferably between 7 to 22.
2.13. The “Affinity therapy/purification media” of embodiment 2.1, which is made of a polymer of the formula, Heparin-CH₂—NH—(CH₂)ₙ-polyether-polyester-(CH₂)ₙ—NH—CH₂-Heparin, wherein the polyether-polyester has MW of ≧5000 daltons, and wherein n is an integer greater than 4, preferably between 7 to 22.
2.14. The “Affinity therapy/purification media” of embodiment 2.1, which is made of a polymer of the formula, Heparin-CH₂—NH—(CH₂)ₙ-polyether-polyamide-(CH₂)ₙ—NH—CH₂-Heparin, wherein the polyether-polyamide has MW of ≧5000 daltons, and wherein n is an integer greater than 4, preferably between 7 to 22.
2.15. The “Affinity therapy/purification media” of embodiment 2.1, which is made of a polymer of the formula, Heparin-CH₂—NH—(CH₂)ₙ-polycarbonate-silicone-urethane-(CH₂)ₙ—NH—CH₂-Heparin, wherein the polycarbonate-silicone-urethane has MW of ≧5000 daltons, and wherein n is an integer greater than 4, preferably between 7 to 22.
2.16. The “Affinity therapy/purification media” of embodiment 2.1, which is made of a polymer of the formula, Heparin-CH₂—NH—(CH₂)ₙ-polyether-silicone-urethane-(CH₂)ₙ—NH—CH₂-Heparin, wherein the polyether-silicone-urethane has MW of ≧5000 daltons, and wherein n is an integer greater than 4, preferably between 7 to 22.
2.17. The “Affinity therapy/purification media” of embodiment 2.1, which is made of a polymer of the formula, Heparin-CH₂—NH—(CH₂)ₙ-polyester-silicone-urethane-(CH₂)ₙ—NH—CH₂-Heparin, wherein the polyester-silicone-urethane has MW of ≧5000 daltons, and wherein n is an integer greater than 4, preferably between 7 to 22.

2.18. The “Affinity therapy/purification media” of embodiment 2.1, which is made of a polymer of the formula, Heparin-CH₂—NH—(CH₂)ₘ—NH—(CH₂)ₙ-polyolefin-(CH₂)ₙ—NH—(CH₂)ₘ—NH—CH₂-Heparin, wherein the polyolefin is a homopolymer or a copolymer with or without functionalization or a polyolefin with different architectures, for example, combs, brushes etc; and having a weight average molecular weight of ≧5000 daltons, and wherein m is ≧2, preferably between 2 and 6, and wherein, n is ≧2, preferably between 7 to 22.
2.19. The “Affinity therapy/purification media” of embodiment 2.1, which is made of a polymer of the formula, Heparin-CH₂—NH—(CH₂)ₘ—NH—(CH₂)ₙ-polyolefin-(CH₂)ₙ—NH—(CH₂)ₘ—NH—CH₂-Heparin, wherein the polyolefin core is a linear low density polyethylene having a weight average molecular weight of ≧5000 daltons, and wherein m is ≧2, preferably between 2 and 6, and wherein, n is ≧2, preferably between 7 to 22.
2.20. The “Affinity therapy/purification media” of embodiment 2.1, which is made of a polymer of the formula, Heparin-CH₂—NH—(CH₂)ₙ-polyolefin-(CH₂)ₙ—NH—CH₂-Heparin, wherein the polyolefin is a homopolymer or a copolymer with or without funetionalization and having a weight average molecular weight of ≧5000 daltons, and wherein m is ≧2, preferably between 2 and 6, and wherein, n is ≧2, preferably between 7 to 22.
2.21. The “Affinity therapy/purification media” of embodiment 2.1, which is made of a polymer of the formula, Heparin-CH₂—NH—(CH₂)ₙ-polyolefin-(CH₂)ₙ—NH—CH₂-Heparin, wherein the polyolefin core is a linear low density polyethylene having a weight average molecular weight of ≧5000 daltons, and wherein n is ≧2, preferably between 7 and 22.
2.22. The “Affinity therapy/purification media” of embodiment 2.1, which is made of a polymer of the formula, R₁—N(CH₃)₂⁺—(CH₂)₂—OP(O)₂^{-—(CH}₂)ₙ-polyethylene-(CH₂)ₙ—OP(O)₂⁻—(CH₂)₂—N(CH₃)₂—R₁⁺, wherein the polyethylene core is a linear low density polyethylene having a weight average molecular weight of from ≧5000 daltons, and wherein n is ≧2, preferably between 7 and 22, and wherein R₁ is a aliphatic alkyl group with number of Carbon atoms between 1 to 21, or substituted and unsubstituted aromatic groups and its higher homologs.
2.23. The “Affinity therapy/purification media” of embodiment 2.1, which is made of a polymer of the formula, X⁻N⁺(CH₃)₂(R₁)—(CH₂CH₂O)ₙ—C(O)NH-polyurethane-NHC(O)—(OCH₂CH₂)ₙ—N⁺(CH₃)₂(R₁)X⁻, wherein polyurethane is an aromatic polycarbonate-polyurethane block copolymer, or a polyether-polyurethane block copolymer, or a polyester-polyurethane block copolymer, or a polyurethane-polyurea block copolymer, or a polyurethane-urea polymer, having a weight average molecular weight of ≧5000 daltons, and wherein n≧1, and wherein the counter ion X is halide such as Cl, Br, or I or other counter-ions with charge localized on an oxygen atom such as sulfonate, mesylate, triflate, etc., and wherein R₁ is an aliphatic alkyl group with number of ≧1 and preferably between 6 and 22.
2.24. The “Affinity therapy/purification media” of embodiment 2.1, which is made of a polymer of the formula, X⁻N⁺(CH₃)₂—(R₁)—(CH₂CH₂)ₙ—O—C(O)NH-polyurethane-NHC(O)—O (CH₂CH₂)ₙ—N⁺(CH₃)₂(R₁)X⁻, wherein polyurethane is an aliphatic polycarbonate-polyurethane block copolymer, or a polyether-polyurethane block copolymer, or a polyester-polyurethane block copolymer, or a polyurethane-polyurea block copolymer, or a polyurethaneurea polymer, having a weight average molecular weight of ≧5000 daltons, and wherein n=≧1, and wherein the counter ion X is halide such as Cl, Br, or I or other counter-ions with charge localized on an oxygen atom such as sulfonate, mesylate, triflate etc., and wherein R₁ is an aliphatic alkyl group with number of ≧1 and preferably between 6 and 22.
2.25. The “Affinity therapy/purification media” of embodiment 2.1, which is made of a polymer wherein the SPACER is a self assembling moiety pendant to the POLYMER backbone.
2.26. The “Affinity therapy/purification media” of embodiment 2.1, which is made of a polymer wherein the SPACER is a self assembling moiety located at the chain ends of the POLYMER.
2.27. The “Affinity therapy/purification media” of embodiment 2.1, which is made of a polymer wherein the POLYMER is obtained by step growth condensation polymerization. Examples of such polymers include polyurethanes (for example derived from polycarbonate, polycaprolactone, polyesters (polyadipate ester) co-segments); polyetheramides (for example PEBAX®); polyetherester (for example Hytrel™); polysulfonamides, polyphosphonate, polyamide, polyamide-imides, polyesteramides, and silicone containing polymers of all of the above.

3. The medical device or prosthesis or packaging assembly of embodiment 1, wherein the polymer comprising the self-assembling molecular moieties in the polymer body is a first polymer making up the entirety of a major portion of the body and having a weight average molecular weight in the range 5000-5,000,000 daltons, or is a second polymer, having a weight average molecular weight in the range 1000-500,000 daltons, which comprises an additive to the first polymer making up the entirety or a major portion of the body.

4. The medical device or prosthesis or packaging assembly of embodiment 3, wherein said first polymer has a weight average molecular weight in the range 50,000-5,000,000 daltons.

5. The device or prosthesis of embodiment 1, configured as an implantable medical device or prosthesis or as a non-implantable disposable or extracorporeal medical device or prosthesis or as an in vitro or ex vivo or in vivo diagnostic device, wherein said device or prostheses has a tissue, fluid, and/or blood-contacting surface.

6. The device or prosthesis of embodiment 1, wherein said polymer body comprises a dense or microporous membrane component in an implantable medical device or prosthesis or in a non-implantable disposable or extracorporeal medical device or prosthesis or as an in vitro or ex vivo or in vivo diagnostic device, and wherein, when said polymer body comprises a membrane component in a diagnostic device, said component contains immuno-reactants.

7. The device or prosthesis of embodiment 1, wherein said device or prosthesis comprises a blood gas sensor, a compositional sensor, a substrate for combinatorial chemistry, a customizable active biochip, a semiconductor-based device for identifying and determining the function of genes, genetic mutations, and proteins, a drug discovery device, an immunochemical detection device, a glucose sensor, a pH sensor, a blood pressure sensor, a vascular catheter, a cardiac assist device, a prosthetic heart valve, an artificial heart, a vascular stent, a prosthetic spinal disc, a prosthetic spinal nucleus, a spine fixation device, a prosthetic joint, a cartilage repair device, a prosthetic tendon, a prosthetic ligament, a drug delivery device from which drug molecules are released over time, a drug delivery coating in which drugs are fixed permanently to polymer endgroups, a catheter balloon, a glove, a wound dressing, a blood collection device, a blood storage container, a blood processing device, a plasma filter or affinity therapy/purification cartridge, connectors, sampling ports, cannulae, tubing, a plasma filtration catheter, a device for bone or tissue fixation, a urinary stent, a urinary catheter, a contact lens, an intraocular lens, eye care product, an ophthalmic drug delivery device, a male condom, a female condom, devices and collection equipment for treating human infertility, a pacemaker lead, an implantable defibrillator lead, a neural stimulation lead, a scaffold for cell growth or tissue engineering, a prosthetic or cosmetic breast implant, a prosthetic or cosmetic pectoral implant, a prosthetic or cosmetic gluteus implant, a penile implant, an incontinence device, a laparoscope, a vessel or organ occlusion device, a bone plug, a hybrid artificial organ containing transplanted tissue, an in vitro or ex vivo or in vivo cell culture device, a blood filter, blood tubing, roller pump tubing, a cardiotomy reservoir, an oxygenator membrane, a dialysis membrane, an artificial lung, an artificial liver, or a column packing adsorbent or chelation agent for purifying or separating blood, plasma, or other fluids.

8. A drug delivery device in accordance with embodiment 7, wherein the drug is complexed to surface-modifying endgroups and is released through diffusion or wherein the drug is associated with, complexed to, or covalently bound to surface-modifying endgroups that degrade and release the drug over time.

9. A packaging assembly in accordance with embodiment 1 comprising a polymer body, wherein the polymer body comprises a plurality of polymer molecules located internally within said body, at least some of which internal polymer molecules have endgroups that comprise a surface of the body, wherein the surface endgroups include at least one self-assembling monolayer moiety,

wherein the polymer comprising the self-assembling monolayer moieties in the polymer body is a first polymer making up the entirety of a major portion of the body and having a weight average molecular weight in the range 5000-5,000,000 daltons, or is a second polymer, having a weight average molecular weight in the range 1000-500,000 daltons, which comprises an additive to the first polymer making up the entirety or a major portion of the body, or

wherein said packaging assembly comprises a plastic bottle and eyedropper assembly containing a sterile solution, wherein said self-assembling monolayer moieties bind an antimicrobial agent and wherein said bound antimicrobial agents maintain the sterility of said solution.

10. A method of immobilizing biologically-active entities, including proteins, peptides, and polysaccharides, at a surface of a polymer body, which polymer body surface comprises a surface of an interface, which method comprises the sequential steps of

contacting the polymer body surface with a medium that delivers self-assembling monolayer moieties containing chemically-reactive groups, capable of binding biologically-active entities to the surface, to the polymer body surface by interaction of chemical groups, chains, or oligomers, said self-assembling monolayer moieties being covalently or ionically bonded to a polymer in the body and comprising one or more chemical groups, chains, or oligomers that spontaneously assemble in the outermost monolayer of the surface of the polymer body or one or more chemical groups, chains, or oligomers that spontaneously assemble within that portion of the polymer body that is at least one monolayer away form the outermost monolayer of the polymer body surface, and

binding said biologically-active entities to said reactive groups,

wherein the polymer comprising the self-assembling monolayer moieties in the polymer body is a first polymer making up the entirety of a major portion of the body and having a weight average molecular weight in the range 5000-5,000,000 daltons, or is a second polymer, having a weight average molecular weight in the range 1000-500,000 daltons, which comprises an additive to the first polymer making up the entirety or a major portion of the body, or

wherein said self-assembling monolayer moieties containing binding groups comprise methoxy ether-terminated polyethyleneoxide oligomers having one or more amino, hydroxyl, carboxaldehyde, or carboxyl groups along the polyethyleneoxide chain.

11. The method of immobilizing biologically-active entities according to embodiment 10, wherein the polymer comprising the self-assembling monolayer moieties in the polymer body is a first polymer making up the entirety of a major portion of the body and having a weight average molecular weight in the range 5000-5,000,000 daltons, or is a second polymer, having a weight average molecular weight in the range 1000-500,000 daltons, which comprises an additive to the first polymer making up the entirety or a major portion of the body.

12. The method of immobilizing biologically-active entities of embodiment 10, wherein said first polymer has a weight average molecular weight in the range 50,000-5,000,000 daltons.

13. The device or prosthesis of embodiment 1, configured as an implantable medical device or prosthesis or as a non-implantable disposable or extracorporeal medical device or prosthesis or as an in vitro or ex vivo or in vivo diagnostic device, wherein said device or prosthesis has antimicrobial activity afforded by self-assembling antimicrobial agents covalently bonded to the polymer chain as an endgroup.

14. A device of embodiment 7, which is microtubing for blood filtration, said tubing being composed of a heparinized copolymer of acrylonitrile and sodium methallyl sulfonate or of a heparinized polyurethane, wherein said tubing has an inside diameter of from 180 to 300 microns and an outside diameter of from 280 to 400 microns, provided that the difference between the inside diameter and the outside diameter ranges from 80 to 120 microns.

### Therapeutic Applications

Affinity therapy is a method to treat autoimmune disorders, sepsis, etc., and is also a means to purify banked blood. Affinity therapy may selectively bind and remove cytokines and other inflammatory molecules, cells, bacteria, viruses, or prions from the blood stream of a human or animal, or from banked blood supply. The method disclosed herein is the manufacture of extracorporeal affinity therapy devices and polymeric materials of construction with bioactive surfaces that selectively binds cytokines, inflammatory cells, viruses, bacteria or prions. Specifically, surface bound heparin is used as the bioactive molecule responsible for the affinity binding. Unbound bioactive components for therapy or purification are not needed to be added for the removal of cytokines or other molecules.

WO 2007/142683 A2 provides polymers having the formula

R(LE)ₓ

wherein R is a polymeric core having a number average molecular weight of from 5000 to 7,000,000 daltons, more usually up to 5,000,000 daltons, and having x endgroups, x being an integer≧1, E is an endgroup covalently linked to polymeric core R by linkage L, L is a divalent oligomeric chain, having at least 5 identical repeat units, capable of self-assembly with L chains on adjacent molecules of the polymer, and, when x>1, the moieties (LE)ₓ in the polymer may be the same as or different from one another, although in many cases, all of the moieties (LE)ₓ in the polymer are the same as one another. The present invention makes use of such polymers to provide novel therapeutic applications and improved blood filtration procedures. The entire disclosure of WO 2007/142683 A2 is expressly incorporated herein by reference.

In these polymers disclosed in WO 2007/142683 A2 and having the formula

R(LE)ₓ

L, for instance, may be a divalent alkane, polyol, polyamine, polysiloxane, or fluorocarbon of from 8 to 24 units in length.

In these polymers disclosed in WO 2007/142683 A2 and having the formula

R(LE)ₓ

E may be an endgroup that is positively charged, negatively charged, or that contains both positively charged and negatively charged moieties. Also, E may be an endgroup that is hydrophilic, hydrophobic, or that contains both hydrophilic and hydrophobic moieties. Also, E may be a biologically active endgroup, such as heparin. In this embodiment, E may be a heparin binding endgroup such as PDAMA or the like that is linked to the polymer backbone via a self assembling polyalkylene spacer of different chain lengths, typically between 8 and 24 units. In another embodiment, E may be an antimicrobial moiety, such as a quaternary ammonium molecules as disclosed in U.S. Pat. No. 6,492,445 B2 (expressly incorporated herein by reference) or an oligermeric compounds such as a poly quat derivatized from an ethylenically unsaturated diamine and an ethylenically unsaturated dihalo compound. The antimicrobial moiety may be an organic biocidal compound that prevents the formation of a biological microorganism, and has fungicidal, algicidal, or bactericidal activity and low toxicity to humans and animals, e.g., a quaternary ammonium salt that bears additional reactive functional group capable of attaching to the polymer main chain, such as compounds having the following formula:

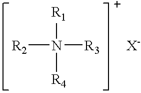

wherein R₁, R₂, and R₃ are radicals of straight or branched or cyclic alkyl groups having one to eighteen carbon atoms or aryl groups and R₄ is an amino-, hydroxyl-, isocyanato-, vinyl-, carboxyl-, or other reactive group-terminated alkyl chain capable of covalently bonding to the base polymer, wherein, due to the permanent nature of the immobilized organic biocide, the polymer thus prepared does not release low molecular weight biocide to the environment and has long lasting antimicrobial activity. Alternatively, E may be an amino group, an isocyanate group, a hydroxyl group, a carboxyl group, a carboxaldehyde group, or an alkoxycarbonyl group. Thus, E may be a protected amino group linked to the polymer backbone via a self assembling polyalkylene spacer of different chain lengths, typically between 8 and 24 units. In some specific embodiments, E may be selected from the group consisting of hydroxyl, carboxyl, amino, mercapto, azido, vinyl, bromo, acrylate, methacrylate, —O(CH₂CH₂O)₃H, —(CH₂CH₂O)₄H, —O(CH₂CH₂O)₆H, —O(CH₂CH₂O)₆CH₂COOH, —O(CH₂CH₂O)₃CH₃, —(CH₂CH₂O)₄CH₃, —O(CH₂CH₂O)₆CH₃, trifluoroacetamido, trifluoroacetoxy, 2′,2′,2′-trifluorethoxy, and methyl.

In these polymers disclosed in WO 2007/142683 A2 and having the formula

R(LE)ₓ

R typically (although not invariably) has a number average molecular weight of from 100,000 to 1,000,000 daltons. R may be, for example, a linear base polymer when x is 2, E is a surface active endgroup, and L is a polymethylene chain of the formula —(CH₂)_ wherein n is an integer of from 8 to 24. In some embodiments, the linear base polymer may be a polyurethane and the endgroup may be a monofunctional aliphatic polyol, an aliphatic or aromatic amine, or mixtures thereof. In many embodiments of the present invention, R will be biodegradable and/or bioresorbable.

In these polymers disclosed in WO 2007/142683 A2 and having the formula

R(LE)ₓ

in some embodiments, at least some of the moieties (LE)ₓ in the polymer may be different from other of the moieties (LE)ₓ in the polymer. In this embodiment of the present invention, the spacer chains may be of different lengths, the endgroups may have different molecular weights and/or identities, or both the spacer chains and the endgroups may be different from one another. One practical application of the varied surface that this embodiment imparts to the polymer would be, for instance, improved ‘rejection’ of both low and high molecular weight proteins when immersed in sea water or body fluids. Using two or more different spacer chain chemistries which self assemble but do not assemble with spacer chains of different chemistry would produce a “patchy” monolayer at the polymer surface (useful e.g. in certain applications for discouraging protein adsorption). An example of this is a polyurethane or polyurea polymer in which about half of the moieties (LE)ₓ in the polymer have E groups derived from a polyethylene oxide having a molecular weight of about 2000 and the reactive monomer that forms the endgroup has the formula HO(CH₂)₁₇(CH₂CH₂O)₄₅CH₃, and about half of the moieties (LE)ₓ in the polymer have E groups that are derived from a polyethylene oxide having a molecular weight of about 5000 and the reactive monomer that forms the endgroup has the formula HO(CH₂)₁₇(CH₂CH₂O)₁₁₄CH₃.

Endgroups that can be used in accordance with this invention include amines, quaternary ammonium salts, olefins, oxiranes, phosphorylcholine, heparin, hyaluranon, and chitosan. The endgroups which may be used herein are inclusive of, but not limited to, endgroups disclosed in WO 2007/142683 A2. The endgroups can be used with or without intermediate self assembling spacers. In accordance with the present invention, the endgroups may be attached both by methods disclosed in WO 2007/142683 A2 {incorporated herein by reference) and by chemical bulk or surface treatment of a precursor polymer to generate the functional endgroup in the final material.

Polymers with bioactive SAME groups are synthesized for blood and body fluids processing applications such as access, removal, oxygenation, dialysis, fractionation, analysis, and/or circulation of body fluids, and their optional return to a human or animal patient. For example, an extracoporeal device may contain different types of polymers depending on the system components. For example, the tubing leading to and from the patient may be composed of a polyurethane, polyolefin, or plasticized PVC. The column containing the high surface area ‘adsorption bed’ can be made from polycarbonate and the high-surface-area adsorption media might be made from polyolefins or polyurethanes. The main affinity therapy action occurs in the heparinized high-surface-area media within the cartridge. However, to prevent thrombosis on the other tubing and cartridge surfaces, these materials must also contain heparinized surfaces for their anticoagulant properties. The method disclosed here teaches a method for creating polyurethanes and polyolefins with bioactive surfaces through the use of self assembling monolayer endgroup or sidegroup technology for the use in extracorporeal therapy devices. Those skilled in the art will understand that self-assembling monolayer endgroups can be appended to a variety of other polymers as well.

SAME polymers are used to fabricate a configured article from the surface-modified polymer, or a coating or topical treatment on an article made from another material. In accordance with this invention, any of the available methods of polymer fabrication can be used, including thermoplastic, solvent-based, water-based dispersions, evaporative depositions, sputtering, dipping, painting, spraying, 100%-solids single component or multi-component processing, machining, thermo-forming, cold forming, etc.

The configured article can be allowed to spontaneously develop the surface of interest by the diffusion/migration of the endgroups to the surface of the configured article and self assembly of those endgroups in the surface. In accordance with this invention, environmental conditions—for maximizing the rate of self assembly and/or the quality of the self-assembled monolayer—can be determined with the optional use of sensitive, surface-specific analytical methods like Sum Frequency Generation Vibrational Spectroscopy (SFG), contact angle goniometry, Atomic Force Microscopy, etc., or through the use of functional testing of the surface after preparation using the candidate environmental condition(s): for instance, time, temperature, and the nature of the fluid or solid in contact with the polymer surface. Functional testing of candidate surface/pretreatment combinations may be done in the actual application in which the surface will be used, or by use of an in vitro test that predicts performance of the surface in the actual application.

SAME technology can also be used for the optional binding of functional, biomimetic, and/or (biologically) active moieties to the surface optimized as described above, or to the non-optimized surface of the configured article produced as described above.

Specific devices or components that can be made from SAME containing materials include: a blood collection device, a blood storage container, a blood processing device, a plasma filter, a plasma filtration catheter, pumps and circulatory assist devices, medical tubing, filters, fittings, cannulae, blood filter, blood tubing, roller pump tubing, a cardiotomy reservoir, an oxygenator membrane, a dialysis membrane, a column packing adsorbent or chelation agent for purifying or separating blood, plasma, or other fluids.

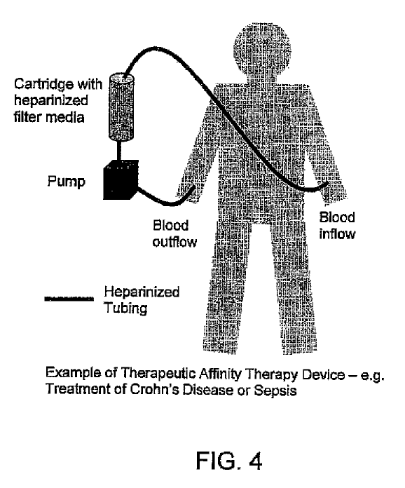

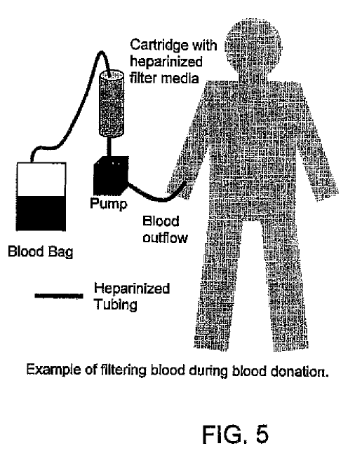

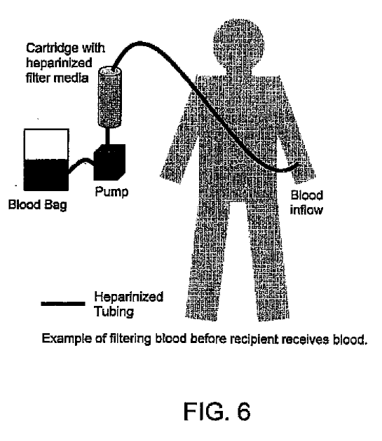

FIG. 4 is a schematic depiction of the use of heparinized tubing and heparinized filter media for blood purification in accordance with the present invention. FIGS. 5 and 6 are schematic depictions of the use of a heparinized blood bag, heparinized tubing, and heparinized filter media for blood collection and transfusion in accordance with the present invention.

### Examples

### Example 1

### Heparinized Micro-Tubing

An Example of micro-tubing for hemofilter application has an inside diameter (ID) of 240 micron and an outside diameter (OD) of 340 micron, with wall thickness of 50 micron. The micro-tubing is made from thermoplastic materials such as acrylonitrile & sodium methallyl sulfonate copolymer or polyurethanes, and has surface modifying endgroups for subsequent heparinization. Specific example of heparinizing tubing: Into 10 liters DI water, 4.0 grams partially degraded heparin (degraded by nitrous acid or periodate) and 0.36 grams sodium chloride are dissolved. The pH of this solution is adjusted to 3.9-4.0 with dilute hydrochloric acid. Then 0.31 grams NaBH₃CN are added and the pH is checked again to ensure it falls between 3.9 and 4.0. The heparin solution is circulated through the medical devices made from micro-tubing with an amino group as the surface modifying endgroup. The circulation of heparin solution is conducted for 48 to 72 hours at room temperature, and the pH of the solution is adjusted to between 3.9 and 4.1 every 12 hours. Another 0.15 grams NaBH₃CN is added into the heparin solution 24 hours after the start of the heparinization reaction. After heparinization, the micro-tubing is flushed with distilled water to remove non-covalently bound heparin.

### Example 2

### Polyurethane Beads with Amine Functional Self Assembling Monolayer Endgroups

Beads are made from polycarbonate-urethane copolymer synthesized with dodecanediamine end groups. During synthesis, an excess of H₂N—(CH₂)₁₂—NH₂ is reacted at the end of the polyurethane reaction (—NCO/—NH₂ ratio kept <1) which creates amine end-groups on the polymer chains. These amine end groups on the polymer will be available for the reaction with partially degraded heparin (with aldehyde groups). This procedure is very similar to the Carmeda process, although no pretreatment/chemical reactions are required to create an aminated surface since the amine functionality is created during polymer manufacturing. Below is the proposed reaction mechanism for this method. Bionate is a thermoplastic polyurethane with aliphatic polycarbonate soft segment and aromatic hard segment. Virtually any other polyurethane midblock may also be used.

Other diamines with hydrophilic poly(ethylene glycol), such as the JEFFAMINE ED series from Huntsman International LLC, can also be used to introduce reactive —NH₂ on the surfaces, especially for the applications in contact with aqueous media (such as blood).

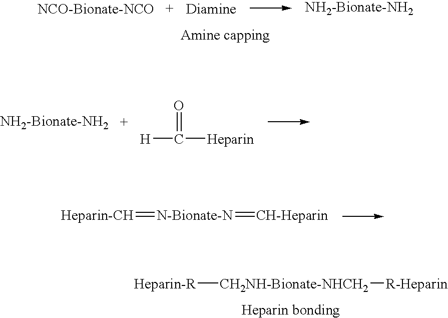

By using a diamine end group with a C₈-C₁₈ spacer, it is believed that the alkane group will cause surface self assembly that presents reactive amines as the head group. This method is defined in the SAME patent and would be useful for other post fabrication attachment of bioactive molecules such as drugs and/or antimicrobial agents.

### Example 3

### Polyurethane Tubing with C₁₈ Self Assembling Monolayer Endgroups Heparinized with Photolinkable Heparin

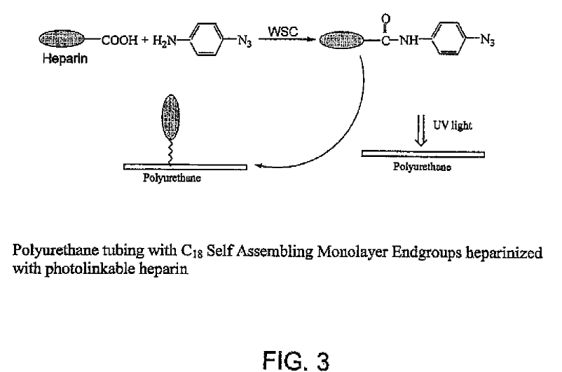

Heparin has very low solubility in organic solvents, therefore only a small amount of heparin can be immobilized on polymer surfaces when organic solutions are employed. The approach illustrated in FIG. 3 and outlined as follows avoids this barrier by using an aqueous solution: A polyurethane with octadecanol SAME groups is synthesized; Tubing is extruded from the SAME containing polymer; A Photosensitive group (e.g. aryl azide) is introduced onto heparin by the reaction between —COOH groups along the heparin polymer chain and —NH² on azidoaniline in the presence of water soluble carbodiimide (WSC). The concentration of heparin can be as high as 10 weight-% t in water. Apply the aqueous solution prepared in Step (c) on the surface of polyurethane. Under UV illumination for 5 minutes, heparin is covalently bound onto the surface through the terminal methyl group of the C₁₈ SAME. Wash the coated materials with water to remove non-covalently bound heparin.

The benefits of this approach include: No pre-treatment of the base polymer materials is needed because the covalent bond will occur between the C₁₈ SAME and photolink modified heparin; This coating technology can be applied on almost all polymeric materials; It yields covalent bonding, while many other coating technologies offer ionic bonding (although very strong in some cases, because of the abundance of negative charges along the heparin chain).

In a specific example, 1 gram heparin sodium salt, 0.43 grams 4-azidoaniline hydrochloride, and 0.55 grams N-(3-dimethylaminopropyl)-N′-ethylcarbodiimide hydrochloride (WSC) are dissolved in 100 mL deionized water. The pH of the solution was adjusted to 4.70-4.75, followed by reacting for 24 hours at 4° C. with stirring in drakness. The unreacted 4-azidoaniline hydrochloride and WSC can be removed by ultrafiltration or dialysis. Exposure to light should be minimized during synthesizing and purifying the photoactive heparin solution. This heparin solution is applied on the top of SAME-modified polyurethane film, following by exposure to mercury-vapor UV light source for 5 to 10 minutes. The heparin-coated polyurethane film is then washed with copious amount of DI water to remove any physically bound heparin.

### Example 4

### Polyurethane with Reactive Surface Assembled SAME and Coupling with Heparin Using a Dual Functional Coupling Agent

Polyurethane with 8-hydroxy 1-octene SAME is synthesized. Tubing is extruded from the SAME containing polymer. Tubing with terminal C═C group of SAME is treated with a coupling agent such as epoxy silane via a hydrosilylation reaction in presence of platinum catalyst such as Karstedt catalyst. The epoxy functional group is attached to the surface for subsequent reaction with heparin or other biologically active agents.

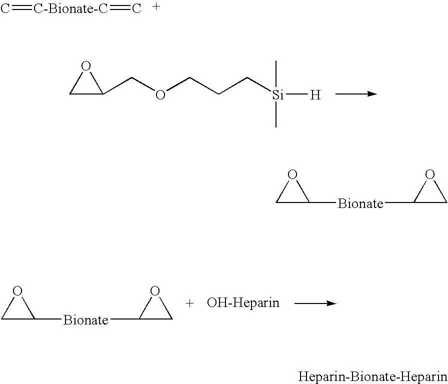

### Example 5

### Polyethylene Cartridge Housing with Heparinized Self Assembling Monolayer Side Chains

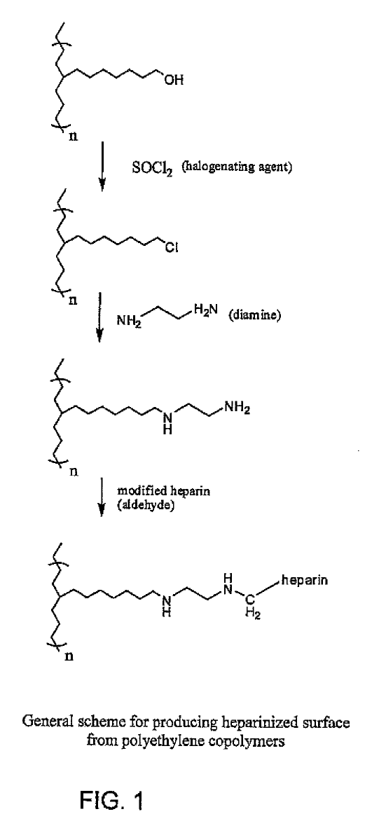

FIG. 1 outlines a general scheme for the modification of a polyolefin surface(s) which contain, for example, a hydroxyl terminated side chain that self assembles. In this example, the hydroxyl group on the terminated side group of the polyethylene backbone is first reacted with a suitable reagent to create a halogenated reactive site. Further examples of halogenating materials include halogen gas and PCl₅. The halogenated side group created above is then reacted with, for example, an excess of diaminoalkane (ethylene diamine, propyl-diamine, (H₂N(CH₂)ₙ—NH₂ as example), which creates an secondary amine linkage and primary amine reactive end group. Protection of one of the amine groups of the diamine can be accomplished prior to surface reaction if necessary to prevent surface crosslinking. Alternatively, the halogenated polyolefin may be treated with ammonia to generate a primary amine functionalized polyolefin. The surface modification of incorporating a reactive amine group (for heparin binding) may be done on a hydroxyl functionalized polyolefin article using the above disclosed chemistry. The free amine is then reacted with aldehyde modified heparin (as in the Carmeda process), to produce an article having covalently bonded heparin to the surface of the polyethylene article.

Polyethylene, polypropylene, PE-PP copolymers (of varying Mw and tacticity), polyethylene-polyhexene (LLDPE) and LDPE having hydroxylated surfaces which can be modified with heparin (as examples containing modified heparin surfaces) are examples of these types of materials. Included by way of example are polyethylene-polybutene-(10-undecen-1-ol) terpolymers having unique material/physical properties which provide soft flexible material for non-rigid tissue support and scaffolding.

FIG. 1 illustrates a general scheme for producing a heparinized surface from polyethylene copolymers. Changes in the material properties of the polyolefin such as stiffness and crystallinity are related to the co-monomer composition and polymer molecular weight. In addition, suitable blends of non-miscible polymers, also modified for bioactive molecule binding could be produced.

Additional examples of polyolefin surfaces modified with reactive sites available for this chemistry include (but are not limited to) olefinic substitutions (such as polymerizations with hexadiene, octadiene, or decadiene as co-monomer. In this connection, see Lee et al., “Copolymerization of Olefins and Dienes with Homogeneous and Heterogeneous Catalysts”, Eur. Polym. J., 1997, 33Z4, 447-451; Tynys et al., “Copolymerisation of 1,9-decadiene and propylene with binary and isolated metallocene systems”, E. Polymer, 2007, 48, 2793-2805; and Naga et al., “Copolymerization of Propane and Nonconjugated Diene Involving Intramolecular Cyclization with Metallocene/Methylaluminoxane”, Macromolecules, 1999, 32, 1348-1355. Amino-functionalized polyolefin copolymers are also usable in the present invention. See Schneider et al., “Aminofunctional linear low density polyethylene via metallocene-catalysed ethene copolymerization with N,N-bis(trimethylsilyl)-1-amino-10-undecene”, Polymer, 1997, 38, (10), 2455-2459. Terpolymers of these types are also included. The foregoing publications are incorporated herein by reference.

In a specific example, copolymer was synthesized from ethylene and 1-amino-10-undecene by using a metallocene catalyst, and the content of the amine-capped moieties can be varied depending on the desired active amine concentration. This aminated copolymer was heparinized using two different approaches.

Approach 1: sodium salt of heparin degraded by nitrous acid or periodate was dissolved in DI water to make a 100 grams 0.5% wt solution, and the pH of this solution was adjusted to 3.9. Twenty-five (25) milligrams sodium cyanoborohydride was added into the solution, and the pH was re-adjusted to between 3.9 to 4.2. Immerse 15 grams aminated PE beads in the aqueous solution at 60° C. for 2 hours under stirring (The reaction time can be extended up to 48 hours if lower temperature, e.g. 20° C., was used). During the coupling reaction, pH of the heparin was checked and adjusted frequently to maintain between 3.9 to 4.2.

Approach 2: One (1) grain heparin sodium salt and 0.55 grams N-(3-dimethylaminopropyl)-N′-ethylcarbodiimide hydrochloride (water-soluble carbodiimide, WSC) was dissolved in 150 grams DI water, and the pH of this solution was adjusted to between 4.70-4.75. Twenty (20) grams aminated PE beads were immersed in this aqueous solution with agitation to ensure sufficient contact at 4° C. for 48 hours. After the heparin immobilization in both approaches, the PE beads, were washed with copious amount of DI water to remove non-covalently bound heparin.

### Example 6

### Polyolefin Materials with Phosphoryl Choline Functionality for Antithrombogenic Properties

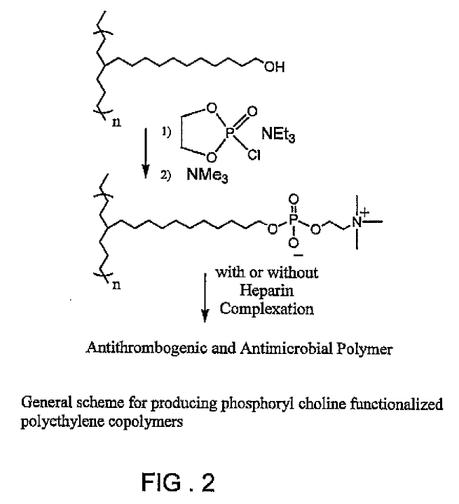

Another method of creating biocompatible and antithrombogenic materials is by introduction of biomimetic groups in the polymer. Incorporation of Phosphoryl choline (PC),—the hydrophilic moiety in naturally occurring phospholipids present in the cell membrane—has been investigated extensively to prepare enhanced blood compatible materials. The minimal interaction of plasma proteins with the polymer surface is believed to suppress the activation of the blood cascade systems. Polyolefins functionalized with hydroxyl groups can be elaborated to polymers bearing zwitterionic PC groups as depicted in FIG. 2. PC modified polyolefins can also exhibit antimicrobial properties with or without incubation of the polymer with heparin.

### Example 7

### Thermoplastic Polyurethane Materials with Antimicrobial Functionality

Polyurethanes with antimicrobial properties can be prepared using a monofunctional antimicrobial agent as a SME (surface-modifying endgroup) or SAME (self-assembling monolayer endgroup). These monofunctional antimicrobial agents contain a reactive group such as a hydroxyl, an amine, a carboxylic acid, etc, and therefore can be covalently attached to the polyurethane chain. Examples of these proven antimicrobial agents includes penicillin, mono-functional polyquaternium, slime quaternaryammonium compounds, and other quaternized ammonium halides. A specific example includes a quaternized amine mono-functional PVP. The use of a SAME with an antimicrobial head group may improve the surface coverage of antimicrobial agents and therefore the biocidal efficacy.

A thermoplastic polyurethane bearing antimicrobial functionality is described in the following formula, wherein PCU is polycarbonate urethane bulk chain, R₁, R₂, and R₃ are radicals of straight, branched, or cyclic alkyl groups having one to eighteen carbon atoms or aryl groups that are substituted or unsubstituted. R₄ is an amino, hydroxyl, isocyanate, vinyl, carboxyl, or other reactive group terminated alkyl chain that react with polyurethane chemistry.

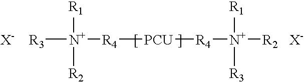

Illustrative of such suitable quaternary ammonium germicides for use in the invention is one prepared from N,N-trimethylamine and 2-chloroethyloxyethyloxyethanol to form a quaternary salt. This quaternary is used as a surface modifying endgroup (SME) in preparing thermoplastic polyurethanes (B) in bulk or in solution. Self assembly of this SME occurs at the surface through the intramolecular interaction of the glyme groups.

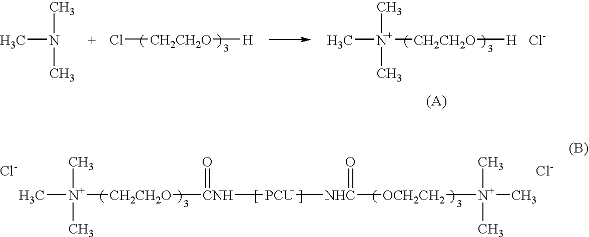

The present invention has been described hereinabove in terms of a preferred embodiments. However, modifications of and additions to these embodiments will become readily apparent to persons skilled in the relevant arts upon a reading of the foregoing description. It is intended that all such additions and modifications form a part of the present invention to the extent they fall within the scope and spirit of the several claims appended hereto.

1. An in vitro, ex vivo, or in vivo medical device or prosthesis or packaging assembly comprising a polymer body comprising at least one polymer having the formula
R(LE)ₓ
wherein
R is a polymeric core having a number average molecular weight of from 5,000 to 7,000,000 daltons, and having x endgroups,
x is an integer≧1,
E is an endgroup covalently linked to polymeric core R by linkage L,
L is a divalent oligomeric chain having at least 5 repeat units and is capable of self-assembly with L chains on adjacent molecules of the polymer, and the moieties L and/or E in the polymer(s) may be the same as or different from one another in composition and/or molecular weight, wherein the polymer body comprises a plurality of polymer molecules located internally within said body, at least some of which internal polymer molecules have endgroups that comprise a surface of the body, wherein the surface endgroups include at least one self-assembling moiety.

2. The medical device of claim 1, which is made from a heparinized filtration or affinity therapy/purification medium constructed of a polymer of the formula Heparin-CH₂—NH-SPACER-POLYMER-SPACER-NH—CH₂-Heparin, wherein POLYMER is a polymeric core with a MW of ≧5,000 daltons and obtained by free radical addition polymerization, or by ionic polymerization, or by step growth condensation polymerization, wherein SPACER is a chemical moiety that is capable of self assembly by means of van der Waals interactions, or by electrostatic interactions, or by hydrogen bonding, or by ionic forces.

3. The medical device of claim 2, wherein said polymer has a formula selected from the group consisting of:
(a) Heparin-CH₁—NH—(CH₂)ₙ-polycarbonateurethane-(CH₂)ₙ—NH—CH₂-Heparin, wherein the polycarbonateurethane has a MW≧5,000 daltons, and wherein n is an integer greater than 4;
(h) Heparin-CH₂—NH—(CH₂)ₙ-polyetherurethane-(CH₂)ₙ—NH—CH₂-Heparin, wherein the polyetherurethane has a MW of ≧5.000 daltons, and wherein n is an integer greater than 4;
(c) Heparin-CH₂—NH—(CH₂)ₙ-polyetherpolyester-(CH₂)ₙ—NH—CH₂-Heparin, wherein the polyether-polyester has a MW of ≧5,000 daltons, and wherein n is an integer greater than 4;
(d) heparin-CH₂—NH—(CH₂)ₙ-polyetherpolyamide-(CH₂)ₙ—NH—CH₂-Heparin, wherein the polyether-polyamide has a MW of ≧5,000 daltons, and wherein n is an integer greater than 4;
(e) Heparin-CH²—NH—(CH₂)ₙ-polycarbonatesiliconeurethane-(CH₂)ₙ—NH—CH₂-Heparin, wherein the polycarbonate-silicone-urethane has a MW of ≧5,000 daltons, and wherein n is an integer greater than 4;
(f) Heparin-CH₂—NH—(CH₂)ₙ-polyethersiliconeurethane-(CH₂—NH—CH₂-Heparin, wherein the polyether-silicone-urethane has a weight average MW of ≧5,000 daltons, and wherein n is an integer greater than 4;
(g) Heparin-CH₂—NH—(CH₂)ₙ-polyestersiliconeurethane-(CH₂)—NH—CH₂-Heparin, wherein the polyester-silicone-urethane has a MW of ≧5,000 daltons, and wherein n is an integer greater than 4;
(h) Heparin-CH₂—NH—(CH₂)ₘ—NH—(CH₂)ₙ-polyolefin-(CH₂)ₙ—NH—(CH₂)ₘ—NH—CH₂-Heparin, wherein the polyolefin is a homopolymer or a copolymer with or without functionalization or a polyolefin with different architectures, and having a weight average molecular weight of ≧5,000 daltons, and wherein m is ≧2, and wherein, n is ≧2;
(i) Heparin-CH₂—NH—(CH₂)ₘ—NH—(CH₂)ₙ-polyolefin-(CH₂)ₙ—NH—(CH₂)ₘ—NH—CH₂-Heparin, wherein the polyolefin core is a linear low density polyethylene having a weight average molecular weight of ≧5,000 daltons, and wherein m is ≧2, and wherein, n is ≧2;
(j) Heparin-CH₂—NH—(CH₂)ₙ-polyolefin-(CH₂)ₙ—NH—CH₂-Heparin, wherein the polyolefin is a homopolymer or a copolymer with or without functionalization and having a weight average molecular weight of ≧5 000 daltons, and wherein m is ≧2, and wherein, n is ≧2;
(k) Heparin-CH₂—NH—(CH₂)ₙ-polyolefin-(CH₂)ₙ—NH—CH₂-Heparin, wherein the polyolefin core is a linear low density polyethylene having a weight average molecular weight of ≧5,000 daltons, and wherein n is ≧2;
(l) R₁—N(CH₃)₂³⁰—(CH₂)₂—OP(O)₂O⁻—(CH₂)ₙ-polyethylene-(CH₂)ₙ—OP(O)₂O²—(CH₂)₂—N(CH³)₂—R₁⁺, wherein the polyethylene core is a linear low density polyethylene having a weight average molecular weight of from ≧5,000 daltons, wherein n is ≧2, and wherein R₁ is a aliphatic alkyl group with number of carbon atoms between 1 to 21, or substituted and unsubstituted aromatic groups with number of carbon atoms up to 21;
(m) X⁻N⁺(CH₃)₂(R₁)—(CH₂CH₂O)ₙ—C(O)NH-polyurethanecopolymer-NHC(O)—(OCH₂CH₂)ₙ—N⁺(CH₃)₂(R₁)X⁻, wherein polyurethanecopolymer is an aromatic polycarbonate-polyurethane block copolymer, or a polyetherurethane block copolymer, or a polyester-polyurethane block copolymer, or a polyurethane-polyurea block copolymer, or a polyurethane-urea polymer, having a weight average molecular weight of ≧5,000 daltons, and wherein n≧1, and wherein the counter ion X is halide or another counter-ions with charge localized on an oxygen atom, and wherein R₁ is an aliphatic alkyl group with between 6 and 22 carbons; and
(n) X⁻N⁺(CH₃)₂—(R₁)—(CH₂CH₂)ₙ—O—C(O)NH--polyurethanecopolymer-NHC(O)—O (CH₂CH₂)ₙ—N⁺(CH₃)₂(R₁)X⁻, wherein polyurethanecopolymer is an aliphatic polycarbonate-polyurethane block copolymer, or a polyether-polyurethane block copolymer, or a polyester-polyurethane block copolymer, or a polyurethane-polyurea block copolymer, or a polyurethaneurea polymer, having a weight average molecular weight of ≧5,000 daltons, and wherein n=≧1, and wherein the counter ion X is halide or another counter-ions with charge localized on an oxygen atom, and wherein R₁ is an aliphatic alkyl group with between 6 and 22 carbon atoms.

4.-16. (canceled)

17. The medical device of claim 2, wherein said SPACER is a self assembling moiety pendant to the POLYMER backbone.

18. The medical device of claim 2, wherein said SPACER is a self assembling moiety located at the chain ends of the POLYMER.

19. The medical device of claim 2, wherein said POLYMER is obtained by step growth condensation polymerization.

20. The medical device or prosthesis or packaging assembly of claim 1, wherein said internal polymer molecules comprising at least one self-assembling molecular moiety which comprises a major portion of said polymer body and has a weight average molecular weight in the range 5₁000-5,000,000 daltons.

21. The medical device or prosthesis or packaging assembly of claim 20, wherein said internal polymer molecule has a weight average molecular weight in the range 50,000-5,000,000 daltons.

22. The device or prosthesis of claim 1, configured as an implantable medical device or prosthesis or as a non-implantable disposable or extracorporeal medical device or prosthesis or as an in vitro or ex vivo or in vivo diagnostic device, wherein said device or prostheses has a tissue, fluid, and/or blood-contacting surface.

23. The device or prosthesis of claim 1, wherein said polymer body comprises a dense or microporous membrane component in an implantable medical device or prosthesis or in a non-implantable disposable or extracorporeal medical device or prosthesis or as an in vitro or ex vivo or in vivo diagnostic device, and wherein, when said polymer body comprises a membrane component in a diagnostic device, said component contains immuno-reactants.

24. The device or prosthesis of claim 1, wherein said device or prosthesis comprises a blood gas sensor, a compositional sensor, a substrate for combinatorial chemistry, a customizable active biochip, a semiconductor-based device for identifying and determining the function of genes, genetic mutations, and proteins, a drug discovery device, an immunochemical detection device, a glucose sensor, a pH sensor, a blood pressure sensor, a vascular catheter, a cardiac assist device, a prosthetic heart valve, an artificial heart, a vascular stent, a prosthetic spinal disc, a prosthetic spinal nucleus, a spine fixation device, a prosthetic joint, a cartilage repair device, a prosthetic tendon, a prosthetic ligament, a drug delivery device from which drug molecules are released over time, a drug delivery coating in which drugs are fixed permanently to polymer endgroups, a catheter balloon, a glove, a wound dressing, a blood collection device, a blood storage container, a blood processing device, a plasma filter or affinity therapy/purification cartridge, connectors, sampling ports, cannulae, tubing, a plasma filtration catheter, a device for bone or tissue fixation, a urinary stent, a urinary catheter, a contact lens, an intraocular lens, eye care product, an ophthalmic drug delivery device, a male condom, a female condom, devices and collection equipment for treating human infertility, a pacemaker lead, an implantable defibrillator lead, a neural stimulation lead, a scaffold for cell growth or tissue engineering, a prosthetic or cosmetic breast implant, a prosthetic or cosmetic pectoral implant, a prosthetic or cosmetic gluteus implant, a penile implant, an incontinence device, a laparoscope, a vessel or organ occlusion device, a bone plug, a hybrid artificial organ containing transplanted tissue, an in vitro or ex vivo or in vivo cell culture device, a blood filter, blood tubing, roller pump tubing, a cardiotomy reservoir, an oxygenator membrane, a dialysis membrane, an artificial lung, an artificial liver, or a column packing adsorbent or chelation agent for purifying or separating blood, plasma, or other fluids.

25. The device or prosthesis of claim 24, wherein said device is a drug delivery device wherein the drug is complexed to surface-modifying endgroups and is released through diffusion or wherein the drug is associated with, complexed to, or covalently bound to surface-modifying endgroups that degrade and release the drug over time.

26. The device or prosthesis of claim 24, wherein said device is microtubing for blood filtration, said tubing being composed of a heparinized copolymer of acrylonitrile and sodium methallyl sulfonate or of a heparinized polyurethane, wherein said tubing has an inside diameter of from 180 to 300 microns and an outside diameter of from 280 to 400 microns, provided that the difference between the inside diameter and the outside diameter ranges from 80 to 120 microns.

27. The device or prosthesis of claim 1, configured as an implantable medical device or prosthesis or as a non-implantable disposable or extracorporeal medical device or prosthesis or as an in vitro or ex vivo or in vivo diagnostic device, wherein said device or prosthesis has antimicrobial activity afforded by self-assembling antimicrobial agents covalently bonded to the polymer chain as an endgroup.

28. A packaging assembly in accordance with claim 1, wherein the polymer body comprises a plurality of polymer molecules located internally within said body, at least some of which internal polymer molecules have endgroups that comprise a surface of the body, wherein the surface endgroups include at least one self-assembling monolayer moiety,
wherein the polymer comprising the self-assembling monolayer moieties in the polymer body is a first polymer making up the entirety of a major portion of the body and having a weight average molecular weight in the range 5,000-5,000,000 daltons, or is a second polymer, having a weight average molecular weight in the range 1,000-500,000 daltons, which comprises an additive to the first polymer making up the entirety or a major portion of the body, or
wherein said packaging assembly comprises a plastic bottle and eyedropper assembly containing a sterile solution, wherein said self-assembling monolayer moieties bind an antimicrobial agent and wherein said bound antimicrobial agents maintain the sterility of said solution.

29. A method of immobilizing biologically-active entities, including proteins, peptides, and polysaccharides, at a surface of a polymer body, which polymer body surface comprises a surface of an interface, which method comprises the sequential steps of
contacting the polymer body surface with a medium that delivers self-assembling monolayer moieties containing chemically-reactive groups, capable of binding biologically-active entities to the surface, to the polymer body surface by interaction of chemical groups, chains, or oligomers, said self-assembling monolayer moieties being covalently or ionically bonded to a polymer in the body and comprising one or more chemical groups, chains, or oligomers that spontaneously assemble in the outermost monolayer of the surface of the polymer body or one or more chemical groups, chains, or oligomers that spontaneously assemble within that portion of the polymer body that is at least one monolayer away form the outermost monolayer of the polymer body surface, and
binding said biologically-active entities to said reactive groups,
wherein the polymer comprising the self-assembling monolayer moieties in the polymer body is a first polymer making up the entirety of a major portion of the body and having a weight average molecular weight in the range 5,000-5,000,000 daltons, or is a second polymer, having a weight average molecular weight in the range 1,000-500,000 daltons, which comprises an additive to the first polymer making up the entirety or a major portion of the body, or
wherein said self-assembling monolayer moieties containing binding groups comprise methoxy ether-terminated polyethyleneoxide oligomers having one or more amino, hydroxyl, carboxaldehyde, or carboxyl groups along the polyethyleneoxide chain.

30. The method of immobilizing biologically-active entities according to claim 29, wherein the polymer comprising the self-assembling monolayer moieties in the polymer body is a first polymer making up the entirety of a major portion of the body and having a weight average molecular weight in the range 5,000-5,000,000 daltons, or is a second polymer, having a weight average molecular weight in the range 1,000-500,000 daltons, which comprises an additive to the first polymer making up the entirety or a major portion of the body.

31. The method of immobilizing biologically-active entities of claim 29, wherein said first polymer has a weight average molecular weight in the range 50,000-5,000,000 daltons.

32. The medical device a prosthesis or packaging assembly of claim 20, wherein said polymer body further comprises a second polymer, having a weight average molecular weight in the range of 1,000-500,000 daltons, as an additive to said internal polymer molecules.
